(19) United States
(12) Patent Application Publication
(10) Pub. No.: US 2004/0218118 A1
(43) Pub. Date: Nov. 4, 2004

(54) Dye type polarizing film and dye type polarizer

(75) Inventor: Narutoshi Hayashi, Niihama (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/777,670

(22) Filed: Feb. 13, 2004

(30) Foreign Application Priority Data
Feb. 18, 2003 (JP) 2003-039497
Feb. 18, 2003 (JP) 2003-039498

(51) Int. Cl. G02F 1/1335

(52) U.S. Cl. 349/96

(57) ABSTRACT

There is provided a polarizing film of a polyvinyl alcohol film in/on which dichroic dye is adsorbed and oriented, wherein a hue angle H is in a range of 105° to 150°, and a chroma C* is 7 or smaller, providing that a parallel hue is expressed on a chromaticity coordinate of (a*, b*). There is also provided a polarizer comprising a film having the optical compensating function and a polyvinyl alcohol film in/on which dichroic dye is absorbed and oriented, wherein a hue angle H is in a range of 105° to 150°, and a chroma C* is 9 or smaller providing that a parallel hue thereof is expressed on a chromaticity coordinate of (a*, b*).

### FIELD OF THE INVENTION

The present invention relates to a dye type polarizing film of a polyvinyl alcohol film. The present invention also relates to a dye type polarizer.

### BACKGROUND OF THE INVENTION

A polarizer, which is obtained by laminating a protecting film on one surface or both surfaces of polarizing film, is widely used in a liquid-crystalline display (LCD). Recently, the liquid-crystalline display has been utilized in many utilities such as a car navigation system and instruments which are observed from a driving seat of an automobile, a portable telephone, a portable information terminal, an amusement equipment and a stationary in addition to a note type personal computer, a liquid-crystalline monitor and a liquid-crystalline television. According to the various purpose for using polarizer, there are many requirements for its optical properties.

A polarizing film includes an iodine type polarizing film of a polyvinyl alcohol film in and on which iodine is adsorbed and oriented, and a dye type polarizing film of a polyvinyl alcohol film in and on which a dichroic dye is adsorbed and oriented. The iodine type polarizer which is composed of an iodine type polarizing film of a polyvinyl alcohol film as polarizing layer has the high ability for polarizing and has the lower durability, while the dye type polarizer which is composed of a dye type polarizing film of a polyvinyl alcohol film as polarizing layer has the very high durability. Therefore, the dye type polarizer is usually used in a liquid-crystalline projector, in particular, a temperature of which is risen by exposure to the intense light upon use, and in automobile-mounting utility which is in the environment of a significantly changing temperature and requires the high durability, for example, a car navigation system and instruments of an automobile.

Regarding such the dye type polarizer or a dye type polarizing film, there have previously been made many proposals. For example, JP No. 6-337312A describes that at least one specific metal-containing diazo dye, and at least two kinds of dyes selected from another metal-containing diazo dye, a specific trisazo dye and a specific direct dye described in Color Index are combined, and the combination is applied to a polarizing film substrate such as a polyvinyl alcohol film, and JP No. 7-159615A describes that a specific trisazo or disazomonoazoxy dye, or a specific metal-containing trisazo or disazomonoazoxy dye is applied to a polarizing film substrate and, further, these dyes are used by combining at least two kinds of other dyes.

JP No. 8-240715A describes to the effect that a polyvinyl alcohol film having a high polymerization degree is uniaxially stretched in a dry manner, then the dye is absorbed and oriented therein and thereon and, thereafter, this is treated with an aqueous boric acid solution at a high temperature of 70 to 85° C., whereby a polarizing film having a high transmittance and a high polarizing degree can be obtained. In this reference, many dyes as a dye to be used are described.

In addition, JP No. 2000-329936A and JP No. 2000-329941 A describe that a polarizing film having a transmittance of 0.3% or lower in a wavelength range of 400 to 500 nm when irradiated with the linear polarized light having a parallel vibrating plane to an absorbing axis direction of a polarizing film, and a transmittance of 77% or higher in a wavelength range of 430 to 500 nm when irradiated with the linear polarized light having a vibrating plane orthogonal to an absorbing axis direction is effective in displaying a natural color by a liquid crystal projector a natural color display, and these references also exemplify various dyes as an usable dye. And, these references describe a combination of C. I. Direct Orange 39 and C.I. Direct Red 81 as a preferable example of a dye.

Further, JP No. 2002-82222A describes that, by using a dye type polarizing film having 4 μm or larger of an adsorption thickness of a dichroic dye, deterioration of the durability can be suppressed, in particular, when the intense light is irradiated from a light source as in a liquid crystal projector, and JP No. 2002-90528A describes that, regarding the same dye type polarizing film, by using a polarizing film having 3.0 or larger of an absorbance at a wavelength of 440 nm, deterioration of the durability can be also suppressed even when the intense light is irradiated from a light source. These references also exemplify many dyes as a usable dye.

Furthermore, an attempt has been made to display neutral gray by specifying a parallel hue and/or an orthogonal hue of a polarizer. For example, JP No. 11-281817A proposes that deviation in hue is suppressed by specifying the relationship between a parallel hue a and b, or a* and b*. In addition, JP No. 2001-311827A proposes that a colorant is contained in any layer constituting a polarizer so that an orthogonal hue a* and b* and a parallel hue a* and b* satisfy the specific relationship, whereby neutral gray can be displayed.

On the other hand, an attempt has been tried in which a transparent protecting layer which is applied on at least one side of a polarizing film is constructed of a film having the optical compensating function. For example, JP No. 8-94838A describes use of at least one optical anisotropic element as a protecting film for a polarizing film. In addition, as a film having the optical compensating function, films in which a liquid-crystalline compound is oriented on a transparent substrate are known. For example, JP No. 6-50206A describes an optical compensating sheet in which a discotic liquid-crystalline compound is oriented.

Meanwhile, when a conventional dye type polarizer is arranged on a transmission type film transistor (TFT) type liquid-crystalline displaying panel which is frequently used in recent automobile-mounting utilities, in particular, in a car navigation system, matching with a liquid-crystalline cell is deteriorated, and the color reproductivity is deficient in some cases. As used herein, color reproductivity refers fidelity of a display in colors of an original image. In the case of the previous dye type polarizer, a display was yellowish in some cases. In particular, when a film having the optical compensating function is used as a transparent protecting layer which is arranged on at least one side of a polarizing film, this tendency was remarkable.

In order to improve the color reproductivity of a liquid-crystalline display on which a dye type polarizer is arranged, the present inventors had been studied a dye type polarizer. As a result, it was found that the color reproductivity of a transmission type TFT liquid-crystalline display is improved by setting a hue angle H when a parallel hue is expressed on a chromaticity coordinate of (a*, b*), in a specific range, and setting a chroma C* in that case, at a specific value, when a polarizer in which a transparent protecting film is laminated on at least one side of a dye type polarizing film with a dichroic dye adsorbed and oriented in and on a polyvinyl alcohol film, which resulted in completion of the present invention.

### SUMMARY OF THE INVENTION

Therefore, an object of the present invention is to improve the color reproductivity of a liquid-crystalline display using a dye type polarizer.

According to the present invention, there is provided a polarizer in which a film having the optical compensating function is laminated on at least one side of a polyvinyl alcohol film with a dichroic dye adsorbed and oriented therein and thereon, wherein when its parallel hue is expressed on a chromaticity coordinate of (a*, b*), a hue angle H is a range of 105° to 150°, and a chroma C* is 9 or lower.

It is preferable that this polarizer has a chroma C* of 3 or lower when an orthogonal hue is expressed on a chromaticity coordinate of (a*, b*). A film having the optical compensating function can be, for example, a film in which a liquid-crystalline compound is coated on a transparent substrate, and a liquid-crystalline compound in this case can be, for example, a discotic liquid-crystalline.

Additionally, according to the present invention, there is provided the above polarizer by using a polarizing film which is a polyvinyl alcohol film with a dichroic dye adsorbed and oriented therein and thereon, wherein a hue angle H of the polarizing film is a range of 105° to 150°, and its chroma C* is 7 or lower.

It is preferable that this polarizing film has a chroma C* of 3 or lower when an orthogonal hue is expressed on a chromaticity coordinate of (a*, b*).

### PREFERABLE EMBODIMENTS OF THE PRESENT INVENTION

The polarizing film of the present invention is a polyvinyl alcohol film with a dichroic dye adsorbed and oriented therein and thereon, wherein when its parallel hue is expressed on a chromaticity coordinate of (a*, b*), a hue angle H is in a range of 105° to 150°, and a chroma C* is 7 or lower. A chromaticity coordinate of a hue (a*, b*) is an orthogonal coordinate system composed of a* and b* which are measured and calculated based on JIS Z 8729. A parallel hue means a hue when two polarizers or polarizing films are overlaid so that respective absorbing axes become parallel, and an orthogonal hue means a hue when two polarizers or polarizing film are overlaid so that respective absorbing axes become orthogonal.

In the present invention, when a parallel hue of a polarizing film is expressed on a chromaticity coordinate of (a*, b*), a hue angle H is in a range of 105° to 150°, and a chroma C* is 7 or lower. The hue angle H is preferably 110° or larger, preferably 140° or smaller. On the other hand, the chroma C* is preferably 6 or smaller. When a hue angle H is smaller than 105° or larger than 150°, matching with a liquid-crystalline cell is deteriorated, and the color reproductivity is decreased. In addition when a chroma C* is larger than 7, matching with a liquid-crystalline cell is also deteriorated, and the color reproductivitiy is decreased. A hue angle H and the chroma C* are values defined by the following equations (1) and (2), respectively.

Hue angel H=tan⁻¹(b*/a*) (1)

Chroma C*=[(a*)²+(b*)²]^{1/2} (2)

This hue angle H is the same as the expression of “ab hue angle h_{ab}” in JIS Z 8729, and a chroma C* is the same as the expression of “ab chroma C*_{ab}” in JIS Z 8729.

It is preferable that a single transmittance and a polarization degree of a polarizer are higher, respectively. Then, it is preferable that a single transmittance is 35% or larger, further 37% or larger, and it is preferable that a polarization degree is 99.3% or larger, further 99.8% or larger.

The polyvinyl alcohol film is a film of a polymer having mainly a vinyl alcohol unit or a modified unit thereof and, specifically, examples include a film of a polymer obtained by saponifying polyvinyl acetate which is a polymer of vinyl acetate, a film of a polymer obtained by saponifying a copolymer of vinyl acetate and another monomer which is copolymerizable with vinyl acetate, for example, unsaturated carboxylic acids, olefins, vinyl ethers, unsaturated sulfonic acids, unsaturated amines, acrylamide and acrylic acid derivatives, further, a film of polyvinyl formal and polyvinyl acetal which are modification of the polymers of the copolymer, and the like. Among these, a film obtained by saponifying polyvinyl acetate is preferable. A saponification degree of a polyvinyl alcohol film is usually 80 to 100 mol %, preferably 98 mol % or larger. A polymerization degree of a polyvinyl alcohol film is usually around 1,000 or larger, preferably 1,500 or larger, further preferably 2,000 or larger. In addition, this polymerization degree is usually around 10,000 or smaller, preferably 5,000 or smaller. A thickness of a polyvinyl alcohol film is, for example, around 10 to 150 μm.

Example of a dichroic dye which is adsorbed and oriented in and on a polyvinyl alcohol film include respective compounds which are classified into the following A to E.

A. A metal containing diazo compound represented, when expressed in the form of a free acid, by the following formula (I)

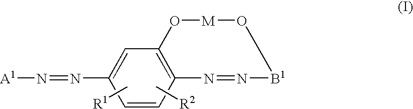

(wherein M represents a transition metal selected from copper, nickel, zinc and iron;

A¹ represents optionally substituted phenyl or optionally substituted naphthyl group;

B¹ represents optionally substituted 1- or 2-naphthol residue, and a hydroxy group of the naphthol is at a position adjacent to an azo group, and makes a complex-bond with a transition metal represented by M;

R¹ and R² represent independently hydrogen, lower alkyl, lower alkoxy, carboxyl, sulfo, sulfamoyl, N-alkylsulfamoyl, amino, acylamino, nitro or halogen group).

B. A trisazo compound represented, when expressed in the form of free acid, by the following formula (II):

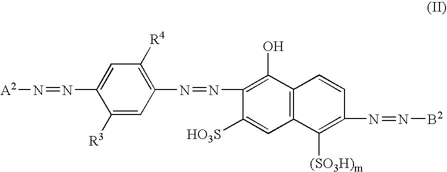

(wherein A²and B² represent independently optionally substituted phenyl or optionally substituted naphthyl group;

R³ and R⁴ represent independently hydrogen, lower alkyl, lower alkoxy, carboxyl, sulfo, sulfamoyl, N-alkylsulfamoyl, amino, acylamino, nitro or halogen group;

m represents 0 or 1)

or a transition metal complex thereof.

C. A biphenyldiazo, trisazo or disazomonoazoxy compound represented, when expressed in the form of a free acid, by the following formula (III):

A³-N═N-Q¹-X-Q²-N═N-B³ (III)

(wherein A³ and B³ represent independently optionally substituted phenyl or optionally substituted naphthyl group;

Q¹ and Q² represent independently optionally substituted phenylene group;

X represents a direct bond, azo or azoxy group).

D. A metal-containing biphenyldisazo, trisazo or disazomonoazoxy compound represented, when expressed in the form of a free acid, by the following formula (IV):

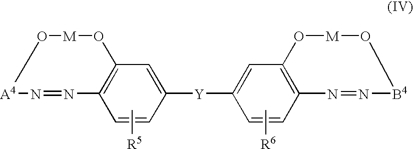

(wherein M represents a transition metal selected from copper, nickel, zinc and iron;

A⁴ and B⁴ represent independently optionally substituted 1- or 2-naphthol residue, and a hydroxy group of the naphthol is at a position adjacent to an azo group, and makes a complex-bond with a transition metal represented by M;

Y represents a direct bond, azo or azoxy group;

R⁵ and R⁶ represent independently hydrogen, lower alkyl, lower alkoxy or sulfo group).

E. Following dichroic dyes described in Color Index (C.I.)

C.I. Direct Yellow 12,

C.I. Direct Yellow 28,

C.I. Direct Yellow 44,

C.I. Direct Yellow 142,

C.I. Direct Blue 1,

C.I. Direct Blue 71,

C.I. Direct Blue 78,

C.I. Direct Blue 168,

C.I. Direct Blue 202,

C.I. Direct Red 2,

C.I. Direct Red 31,

C.I. Direct Red 79,

C.I. Direct Red 81,

C.I. Direct Red 117,

C.I. Direct Red 247,

C.I. Direct Violet 9,

C.I. Direct Violet 51,

C.I. Direct Orange 26,

C.I. Direct Orange 39,

C.I. Direct Orange 107,

C.I. Direct Brown 106,

C.I. Direct Brown 223, and the like.

In the formula (I) and the formula (IV), it is preferable that a transition metal represented by M is copper. In addition, it is preferable that lower alkyl, lower alkoxy group in the aforementioned formulas, and alkyl group in N-alkylsulfamoyl have a carbon number of 1 to 4, and lower alkyl and lower alkoxy group hereinafter have also the same carbon numbers. Further, acyl group in acylamino having a total carbon number of 2 to 4 such as acetyl and propionyl is preferable and examples of halogen include fluorine, chlorine, bromine, and the like.

A¹ in the formula (I), A² and B² in the formula (II), as well as A³ and B³ in the formula (III) are phenyl or naphthyl group, and these phenyl and naphthyl groups may be unsubstituted or substituted. Examples of a group which may be a substituent of this phenyl include sulfo, sulfamoyl, lower alkyl, lower alkoxy, nitro, hydroxy, carboxyl, unsubstituted or mono- or di-substituted amino, halogen group, and the like. Examples of a group which may be a substituent of this amino include lower alkyl, lower alkyl substituted with hydroxy or cyano group, and acyl group having a total carbon number of 2 to 4. Examples of a group which may be a substituent of naphthyl include sulfo, hydroxy, amino group, and the like.

B¹ in the formula (I) as well as A⁴ and B⁴ in the formula (IV) are 1- or 2-naphthol residue which has hydroxy group positioning adjacent to an azo group and makes a complex-bond with a transition metal represented by M, and this naphthol residue may be unsubstituted or substituted. Examples of a group which may be a substituent of this naphthol residue include sulfo, hydroxy, carboxyl, unsubstituted or mono- or di-substituted amino group, and the like. Examples of the group which may be a substituent of this amino include lower alkyl, lower alkyl substituted with hydroxy group, cyano group or the like, acyl group having a total carbon number of 2 to 4, carbamoyl, sulfamoyl, unsubstituted or substituted phenyl, unsubstituted or substituted benzoyl group, and the like. Examples of a group which may be a substituent of phenyl and benzoyl include sulfo, lower alkyl, lower alkoxy group, and the like.

Q¹ and Q² in the formula (III) are phenylene, respectively, and may be unsubstituted or substituted, and Q¹ and Q² may be the same or different. Examples of a group which may be a substituent of this phenylene include hydroxy, lower alkyl, lower alkoxy, sulfo group, and the like. It is preferable that Q¹ and Q² are unsubstituted or mono- or di-substituted phenylene, more preferable is p-phenylene. In addition, X in a formula (III) and Y in the formula (IV) are a direct bond, azo (—N═N—) or azoxy (—N(→O)═N—) group.

R¹ and R² in the formula (X), as well as R² and R⁴ in the formula (II) are hydrogen, lower alkyl, lower alkoxy, carboxyl, sulfo, sulfamoyl, N-alkylsulfamoyl, amino, acylamino, nitro or halogen group. In addition, R⁵ and R⁶ in the formula (IV) are hydrogen, lower alkyl, lower alkoxy or sulfo group.

Compounds represented by the formula (I), the formula (III) and the formula (IV) usually have at least one sulfo or carboxyl group as a water-soluble group in a molecule. As the water-soluble group, sulfo group is particularly preferable and, it is more preferable that the compounds have two or more sulfo groups in a molecule. In addition, similarly, it is preferable that the compound represented by the formula (II) has two or more sulfo groups in a molecule.

The transition metal complex of a trisazo compound represented by the formula (II) refers to a compound in which R⁴ and a hydroxy group (OH) which binding to a naphthalene ring in the formula (II), form —O-M-O—bond (wherein M represents a transition metal selected from copper, nickel, zinc and iron.) Also in this case, it is preferable that M is copper.

Among the aforementioned dichroic dyes, compounds having sulfo or carboxyl group when expressed in the form of a free acid are used usually as the form of an alkali metal salt such as the form of a sodium salt. Those compounds may be used as the form of another alkali metal salt such as a lithium salt and a potassium salt, or as the form of a free acid. Further, those compounds may be used as the form of an ammonium salt, or an amine salt such as an ethanolamine salt and an alkylamine salt.

These dichroic dyes can be all prepared according to the known methods. That is, the metal-containing disazo compound represented by the formula (I) can be prepared, for example, by the known methods described in West Germany Patent Publication No. 32 36 238A, JP No. 64-5623B, and the like, the trisazo compound represented by the formula (II) can be prepared, for example, according to the known methods described in JP No. 2-75672A, the trisazo or the disazomonoazoxy compound among the compounds represented by the formula (III), as well as the metal-containing trisazo or disazomonoazoxy compound among the compounds represented by the formula (IV) can be prepared by utilizing glucose reduction described, for example, in Ind. Eng. Chem., 27,1045(1935), J. Am. Chem. Soc., 73, 1323(1951), and the like.

Examples of the dye of the formula (I) constituting the aforementioned A group, the dye and the copper complex dye thereof of the formula (II) constituting the B group, as well as the dye of the formula (III) constituting the C group include, when expressed in the form of a free acid, dyes represented by the following formulas (I-1) to (I-24), (II-1) to (II-11), and (III-1) to (III-22), respectively. In the following formulas (III-1) to (III-22), a group of the following formula:

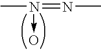

means that it can be azo (—N═N—), azoxy (—N(→O)═N—) group or a mixture of both.

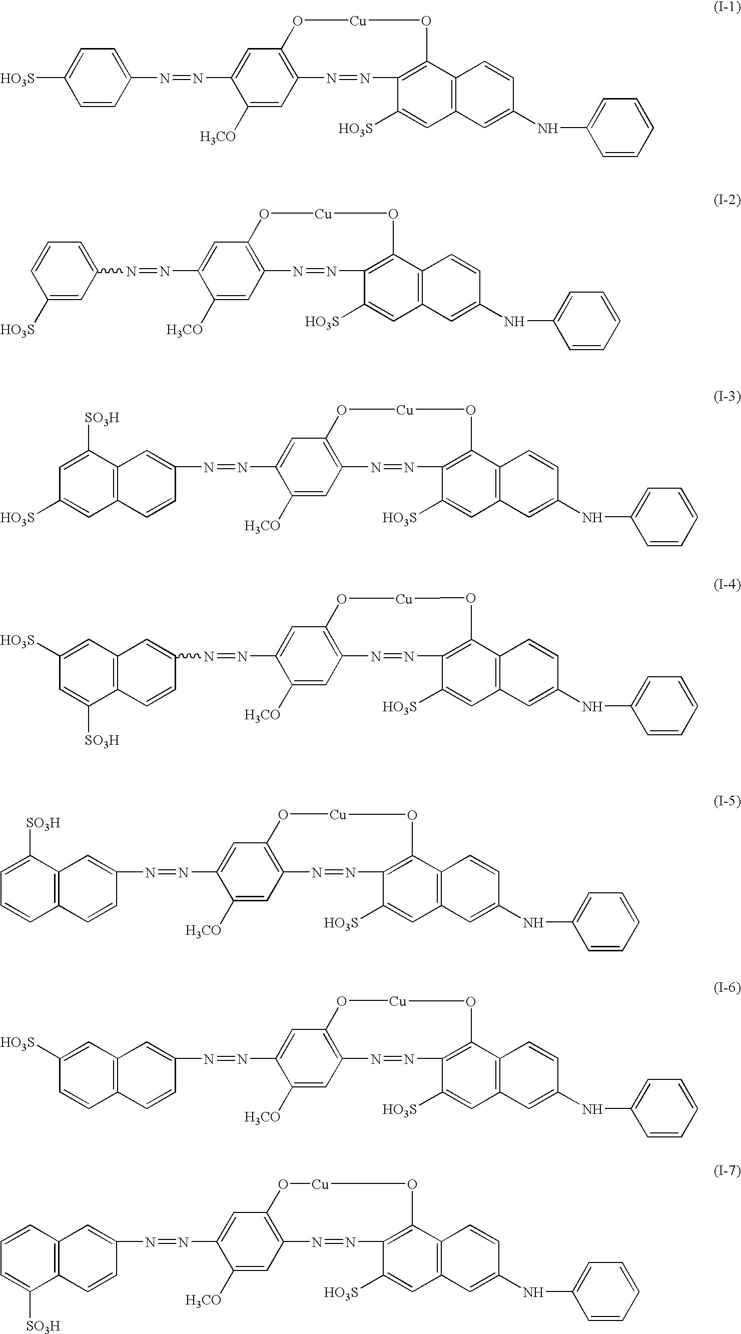

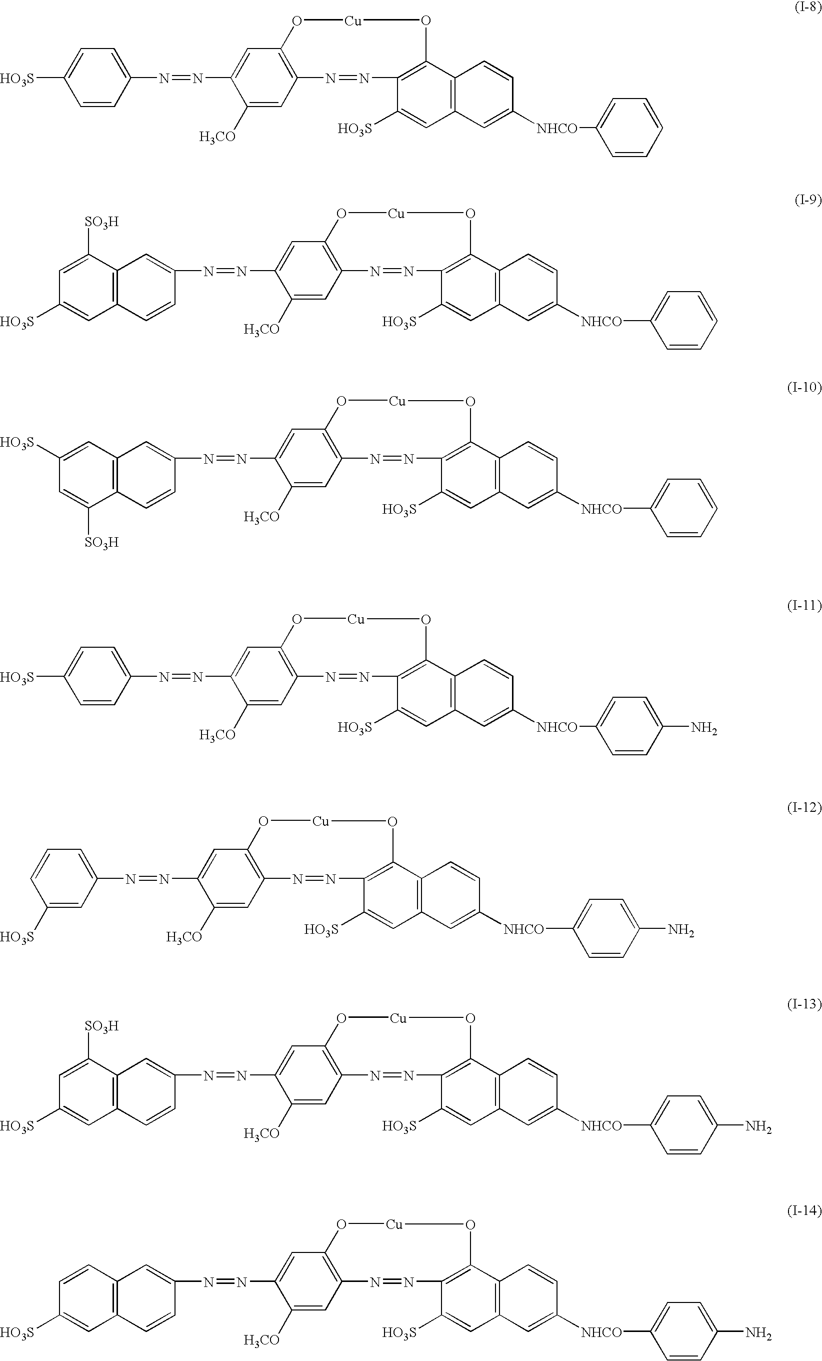

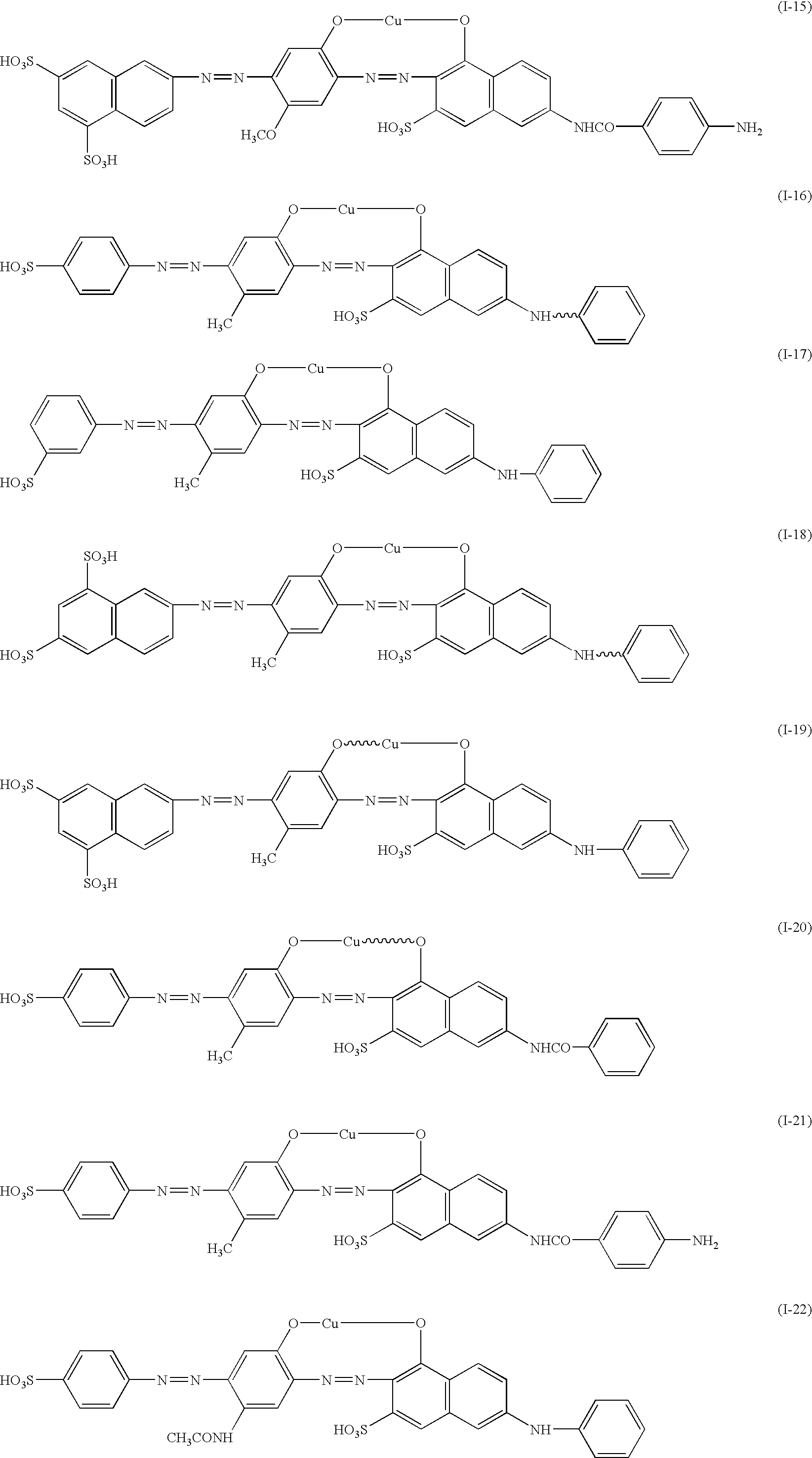

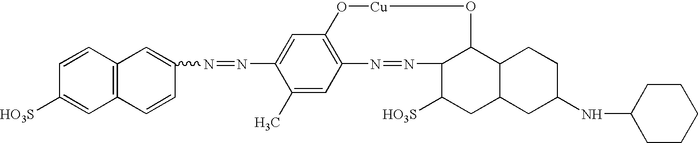

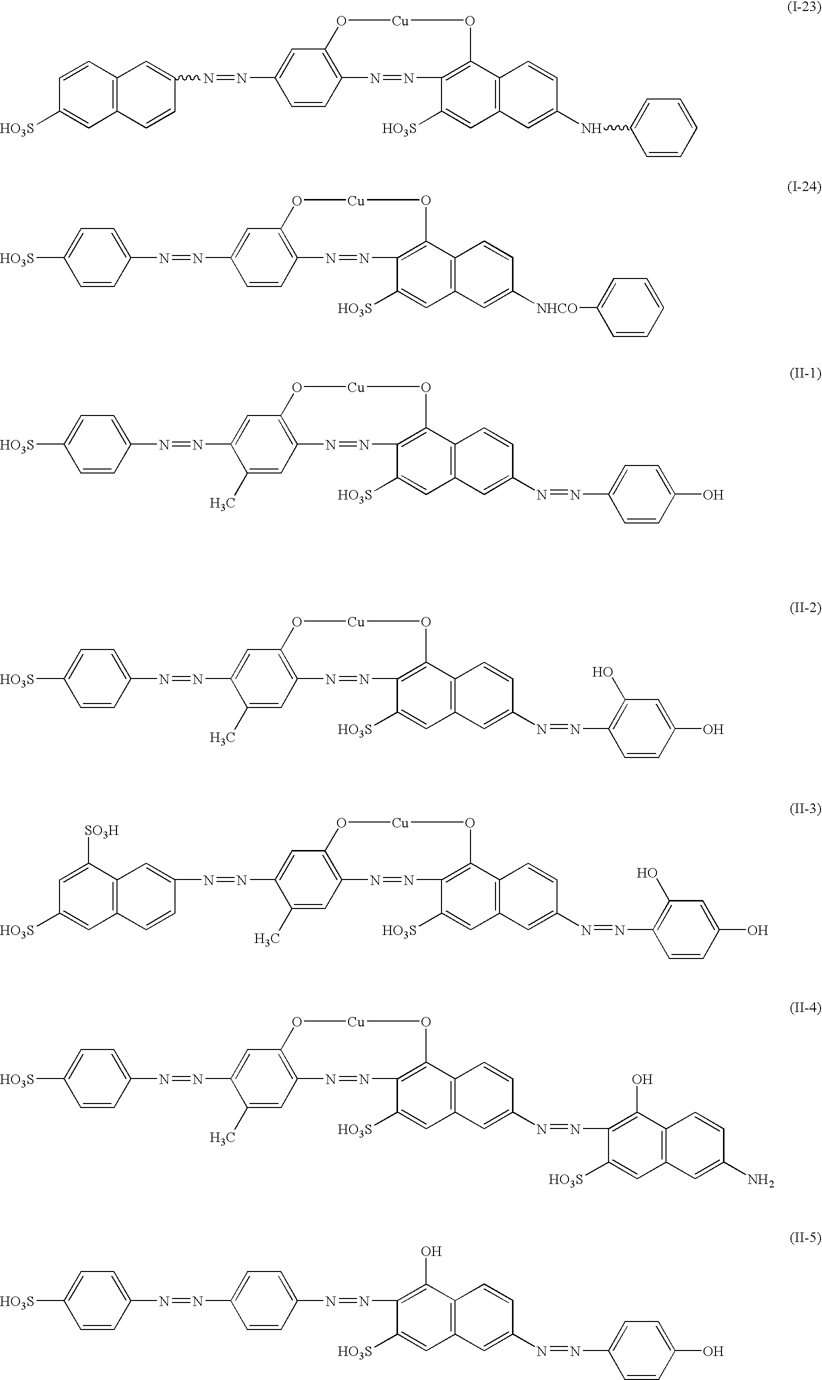

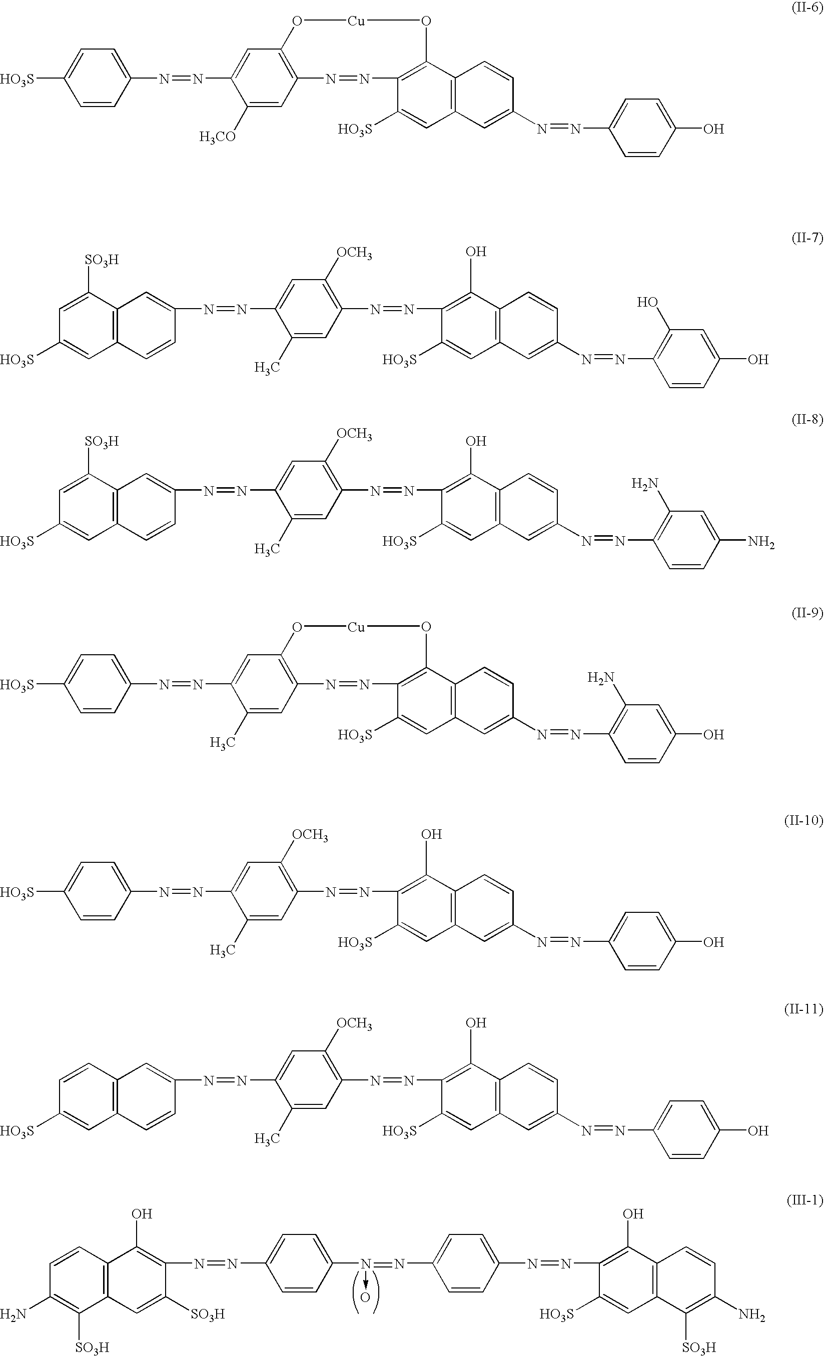

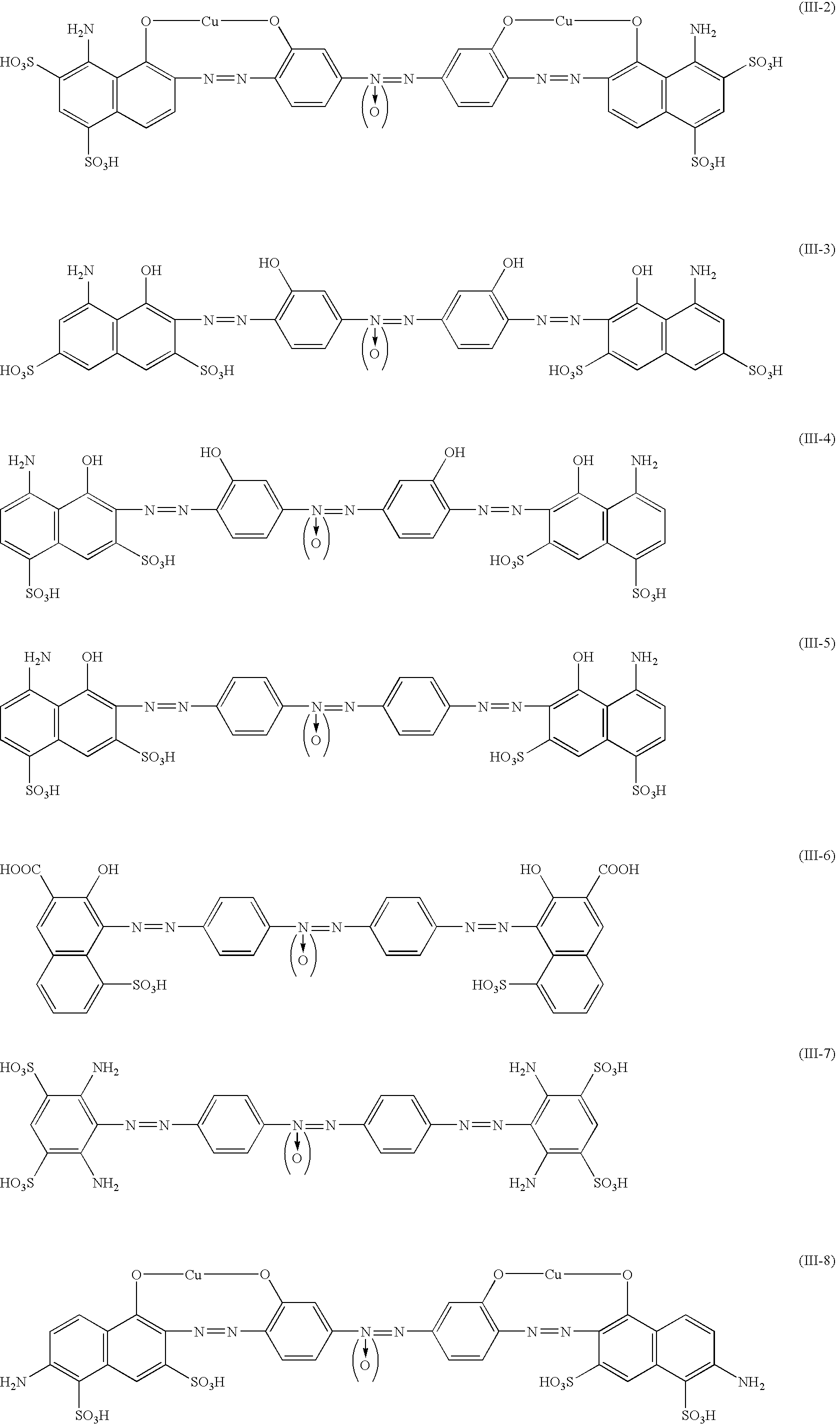

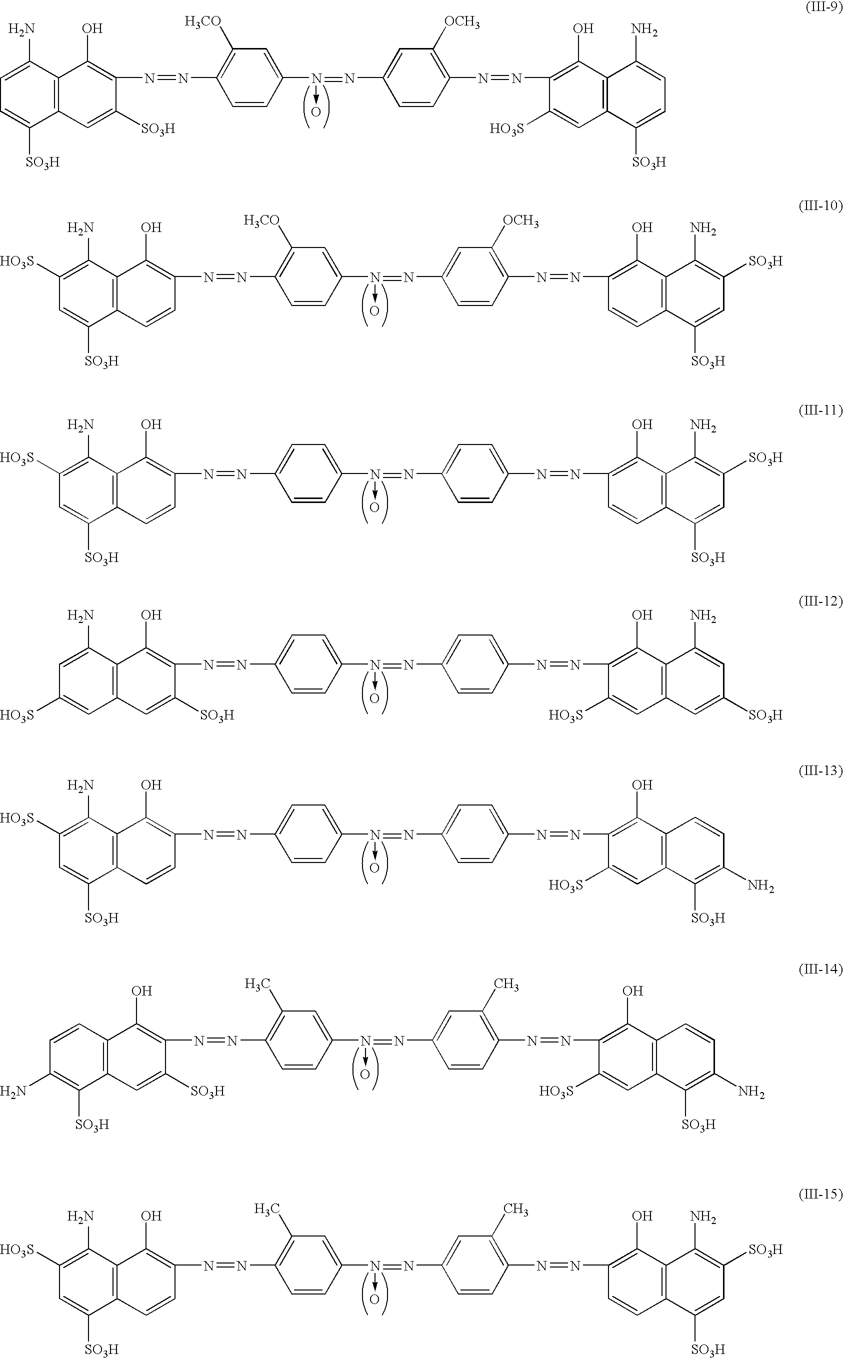

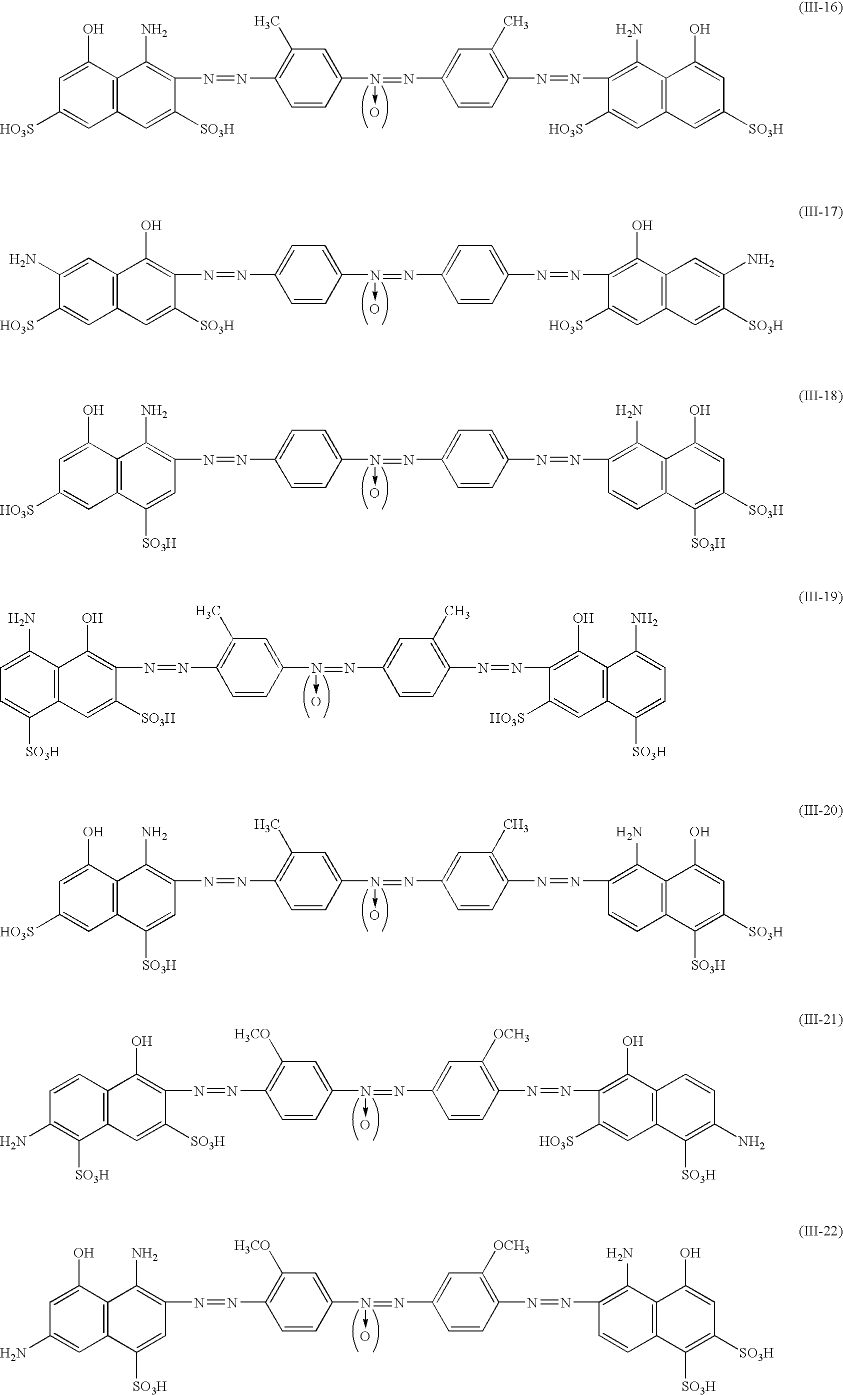

In the present invention, the aforementioned dichroic dye is adsorbed and oriented in and on a polyvinyl alcohol film, the resulting polarizing film has, when a parallel hue is expressed on a chromaticity coordinate of (a*, b*), a hue angle H is in a range of 105° to 150°, and a chroma C* is 7 or smaller. By using two or more kinds of dichroic dyes by combining them upon staining of a polyvinyl alcohol film, those requirements are satisfied.

The present inventors investigated some of currently commercially available polarizers, but could not found polarizers having a polarizing film satisfying the aforementioned hue angle H of 105° to 150°, and the chroma C* of 7 or smaller. In addition, the aforementioned Japanese Patent Application mentioned in the above section of “BACKGROUND OF THE INVENTION2” exemplify an example using some dichroic dyes by combining them. However, when a combination of dichroic dyes disclosed in these References was used, the resulting polarizing film did not show the aforementioned hue angle H of 105° to 150°, and the chroma C* of 7 or smaller.

In order to obtain a polarizing film in which, when a parallel hue is expressed on a chromaticity coordinate of (a*, b*), a hue angle H is in a range of 105° to 150°, and a chroma C* is 7 or smaller, as defined in present invention, it is preferable that at least one kind of a dichroic dye having a maximum absorption wavelength at a wavelength of 600 nm or longer is used, and at least one kind of dichroic dye having a maximum absorption wavelength in a range of a wavelength of 500 to 600 nm is used by combining therewith. It is more preferable that a dichroic dye having a maximum absorption wavelength at a wavelength of 600 nm or longer is selected from the dichroic dyes of the formula (I) constituting the aforementioned A group, and this is used by combining with one or plural dye(s) having a maximum absorption wavelength in a range of wavelength of 500 to 600 nm among the dichroic dyes belonging to the aforementioned B to E groups. Alternatively, it is also effective in some cases that a dye having a maximum absorption wavelength at a wavelength of 500 nm or shorter is further combined for toning.

Among the dichroic dyes represented by the formula (I), a compound represented by the following formula (Ia):

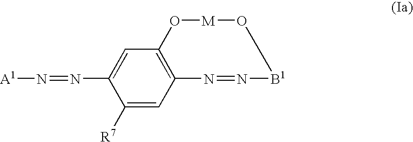

(wherein A¹ and B¹ are the same in the formula (I); R⁷ represents hydrogen, lower alkyl or acylamino group)

is particularly preferable. This formula (Ia) corresponds to a compound in which R² is hydrogen, and R¹ is at a p-position relative to a —O-M- group and is hydrogen, lower alkyl or acylamino group in the aforementioned formula (I). Examples thereof include those shown in the aforementioned formulas (I-16) to (I-24). A compound wherein R⁷ is methyl is effective.

Examples of a combination of suitable dyes for obtaining a polarizing film satisfying a hue angle H and a chroma C* of a parallel hue as defined in the present invention include a combination of a dye corresponding to the aforementioned formula (I-16), a dye corresponding to the aforementioned formula (II-5) and C. I. Direct Orange 39.

In order that the aforementioned dichroic dye is absorbed and oriented in and on a polyvinyl alcohol film, for example, a method of performing stretching a polyvinyl alcohol and staining the stretched polyvinyl alcohol by immersion into an aqueous dichroic dye solution on a polyvinyl alcohol film can be adopted. It is preferable that a polyvinyl alcohol film is treated by immersion in tow arm water before staining. An aqueous solution used in staining is usually such that around 0.0001 to 1 part by weight of a dichroic dye is dissolved in 100 parts by weight of water. When a combination of plural dyes is used, a total concentration of plural dyes used is usually in the above range. A staining aid may be added to an aqueous solution. For example, when mirabilite is used as a staining aid, an amount thereof to be used is around 0.1 to 10 parts by weight relative to 100 parts by weight of water. A higher temperature of an aqueous solution is preferable. For example, around 68 to 80° C. is preferable, and around 70 to 80° C. is more preferable. Since a film is dissolved in an aqueous solution at the temperature being too high, there is an upper limit of a temperature at which continuous treatment is possible.

Stretching of a polyvinyl alcohol film may be performed before treatment by immersion of a dichoric dye into an aqueous solution, or may be performed while performing immersion treatment, or may be performed after immersion treatment, Stretching is usually performed by uniaxial stretching. A method of uniaxial stretching is not particularly limited, but any of wet stretching and dry stretching may be used. A stretching ratio is usually 4 times or larger, preferably 8 times or smaller. In order to uniaxially stretch a polyvinyl alcohol film in a dry manner, as usual, for example, a method of contacting a film with a driving heating roll with applying a backward tension to a film, and longitudinally uniaxially stretching the film, a method of passing a film between a pair of heating rolls to stretch the film, and the like are used. A temperature of a heating roll is not lower than a glass transition temperature of a polyvinyl alcohol, and is usually 160° C. or lower, preferably around 80 to 130° C.

The polyvinyl alcohol film with a dichroic dye absorbed and oriented there in and thereon is usually thereafter subjected to boric acid treatment. The boric acid treatment is performed by immersing the film in a boric acid-containing aqueous solution. The boric acid concentration in this aqueous solution is not particularly limited, but an aqueous solution in which usually around 2 to 15 parts by weight, preferably around 5 to 12 parts by weight of boric acid is dissolved in 100 parts by weight of water is used. A temperature of the boric acid-containing aqueous solution is usually around 60 to 85° C., preferably around 65 to 75° C. A treating time is not particularly limited, but is usually 100 to 1,200 seconds, preferably around 150 to 600 seconds. After the boric acid treatment, water washing and drying as usual afford a polarizing film with a dichroic dye absorbed and oriented therein and thereon.

The polarizer of the present invention is obtained by laminating a film having the optical compensating function on at least one side of a polyvinyl alcohol film with a dichroic dye adsorbed and oriented therein and thereon, wherein when its parallel hue is expressed on a chromaticity coordinate of (a*, b*), a hue angle H is in a range of 105° to 150°, and a chroma C* is 9 or lower.

The hue angle H is preferably 110° or larger, preferably 140° or smaller. The chroma C* is preferably 8 or smaller. When a hue angle H is smaller than 105° or larger than 150°, matching with a liquid-crystalline cell is deteriorated, and the color reproductivity is decreased.

It is preferable that the polarizer of the present invention has a chroma C* of 3 or smaller when an orthogonal hue is expressed on a chromaticity coordinate of (a*, b*). This orthogonal hue chroma C* is more preferably 2 or smaller, further preferably 1 or smaller.

It is preferable that a single transmittance and a polarization degree of a polarizer are higher, respectively. Then, it is preferable that a single transmittance is 35% or larger, further 37% or larger, and it is preferable that a polarization degree is 99.3% or larger, further 99.8% or larger.

A preferable polyvinyl alcohol film used for the polarizer of the present invention is a polarizing film of a polyvinyl alcohol film having a hue angle H in a range of 105° to 150°, and a chroma C* of 9 or lower as mentioned above. It is more preferable that a chroma C* of a polyvinyl alcohol is 3 or smaller, more preferably is 2 or smaller, and most preferably is 1 or smaller.

The optical compensating function in the present invention is to compensate the birefringent property of a liquid-crystalline cell. For example, a film obtained by uniaxially or biaxially stretching a transparent film, a film obtained by coating a liquid-crystalline compound on a transparent substrate, and the like are used. Examples of the liquid-crystalline compound include a discotic liquid-crystalline, a nematic liquid-crystalline, and the like, or liquid-crystalline compounds in which a discotic liquid-crystalline or a nematic liquid-crystalline is bound with a main chain or a side chain of a high molecular compound may be used. These liquid-crystalline compounds are coated on a substrate, then dried and cured to fix the compounds on a substrate film. An optical compensating film in which a discotic liquid-crystalline is coated and oriented is one of preferable films. Such the optical compensating films in which a liquid-crystalline compound is coated and oriented are commercially available, such as “Wide View Film WVA03B” and “Wide View Film WVA12B” available from Fuji Photo Film Co., Ltd., and “Nisseki LC Film”, “Nisseki NH Film” and “Nisseki NR Film” available from Nippon Oil Corp.

When protecting films are applied on both sides of a polarizing film, one of them is the aforementioned film having the optical compensating function and, as the other protecting film, a film having the optical compensating function may be used, or the same films as those used in usual polarizers, such as a cellulose acetate film, an acryl film, a polyester film, a cyclic polyolefin film having a norbornene structure, a polycarbonate film, a polyacrylate film, and a polyethersulfone film may be used. Examples of the cellulose acetate film include triacetyl cellulose film, diacetyl cellulose film, and the like.

A thickness of a protecting film is not particularly limited, but usually around 40 to 200 μm. A protecting film may contain an ultraviolet absorbing agent or the like and, as such the protecting film, commercially available films may be used. Examples of the commercially available protecting film include “Konica KC80UVSF” and “Konica KC80UVN” [all manufactured by Konica Corp.] which are a triacetyl cellulose film, and the like.

The surface of a polarizer may be treated by various functional surface treatments. For example, anti-glare treatment, hard coating treatment, antireflection treatment, antistatic treatment, and the like may be performed. The anti-glare treatment may be performed, for example, by a method of coating an organic bead or an inorganic filler in the state where it is mixed with a resin binder, followed by ultraviolet curing or thermal curing. The hard coating treatment is performed, for example, by a method of coating an acryl series resin, followed by ultraviolet curing or thermal curing. The antireflection treatment is performed, for example, by a method of laminating two or more layers composed of a material selected from inorganic materials such as metal and metal oxide, and organic materials on the surface, to form an antireflection layer. Examples of the metal used include silver or the like, and examples of the metal oxide include titanium oxide, silicon oxide, indium oxide, aluminium oxide, cesium oxide, tin oxide, zirconium oxide, yttrium oxide, tantalum oxide, and the like. Examples of inorganic materials other than these metals and metal oxides include magnesium fluoride or the like. Examples of organic materials include fluorine resin or the like. Examples of a method of laminating these materials include physical methods such as deposition, sputtering and ion plating methods, and coating methods such as roll coating method, gravure coating method, spray coating method, and the like. In order to improve the adherability between an antireflection layer and a protecting film, it is preferable that the surface of a protecting film is subjected to hard coating treatment, corona treatment, chemical cleaning or the like. These surface treatments may be performed on one side or both sides of a polarizer. These surface treatments may be performed plural times.

### EXAMPLES

The present invention will be illustrated in more detail below by way of Examples, but the present invention is not limited by them. A transmittance T (λ) at an arbitrary wavelength λ was measured using a photospectrometer [“UV-2200” manufactured by Shimadzu Corporation]. Unless otherwise indicated, the term of “part” in Examples means “part by weight”.

### Example 1

0.020 Part of C. I. Direct Orange 39, 0.028part of a sodium salt of a dye corresponding to the aforementioned formula (I-16), 0.013 part of a sodium salt of a dye corresponding to the aforementioned formula (II-5) and 2.0 part of mirabilite were dissolved in 100 parts of water to prepare a staining bath. Maximum absorption wavelengths (λmax: in water) of dyes used are as follows:

C. I. Direct Orange 39: about 440 nm,

Dye of formula (I-16): about 610 nm,

Dye of formula (II-5): about 550 nm.

A film of a thickness 75 μm composed of polyvinyl alcohol having a polymerization degree of 2,400 was uniaxially stretched at about 5 times by a method of contacting the film with a driving heating roll at about 120° C. while applying backward tension to the film, to obtain a longitudinally uniaxially stretched film. The film after stretching was immersed into warm water at 60° C., and then immersed into the staining bath as prepared above at 72° C. for 105 seconds to stain the film. Then, the film after staining was immersed into an aqueous solution containing 100 parts of water and 7.5 parts of boric acid at 72° C. for 5 minutes. Further water washing and drying afforded a polarizing film.

In the resulting polarizing film, a single transmittance was 38.9%, a polarizing degree was 99.9%, a hue angle H of a parallel hue was 132°, a chroma C* of a parallel hue was 4.8, and a chroma C* of an orthogonal hue was 0.4. On the both surface of this polarizing film, triacetyl cellulose film was laminated to obtain polarizer. The obtained polarizer was set on upper and lower sides of a transmission type TFT liquid-crystalline display, and the color reproductivity on a screen was good.

### Example 2

0.017 Part of C. I. Direct orange 39, 0.022 part of a sodium salt of a dye corresponding to the aforementioned formula (I-16), 0.012 part of a sodium salt of a dye corresponding to the aforementioned formula (II-5) and 0.5 part of mirabilite were dissolved in 100 parts of water to prepare a staining bath.

A film of a thickness 75 μm of polyvinyl alcohol having a polymerization degree of 2,400 was uniaxially stretched at about 5 times by a method of contacting the film with a driving heating roll at about 120° C. with applying backward tension to the film, to obtain a longitudinally uniaxially stretched film. The film after stretching was immersed into warm water at 63° C., and then immersed into the staining bath as prepared above at 73° C., to stain the film. Then, the film after staining was immersed into an aqueous solution containing 100 parts of water and 7.8 parts of boric acid at 72° C. Further water washing and drying afforded a polarizing film. On one side of this polarizing film, was applied a triacetyl cellulose film [manufactured by Fuji Photo Film Co., Ltd.] and, on the other side, was applied an optical compensating film “Wide View Film WVA03B” manufactured by Fuji photo Film Co., Ltd. in which a liquid-crystalline compound is coated and oriented on a substrate film, and then a polarizer was obtained.

In the resulting polarizer, a single transmittance was 38.1%, a polarizing degree was 99.9%, a hue angle H of a parallel hue was 120.8°, a chroma C* of a parallel hue was 7.2, and a chroma C* of an orthogonal hue was 0.6. This polarizer was set on upper and lower sides of a transmission type TFT liquid-crystalline display, and the color reproductivity on a screen was good.

### Comparative Example 1

The dye type polarizer “Sumikalan ST1822A” commercially available from Sumitomo Chemical Co., Ltd. had a hue angle H of a parallel hue of 98° and a chroma C* of 9.7. When this polarizer was set on upper and lower sides of a transmission type TFT liquid-crystalline display, a screen was yellowish, and the color reproductivity was not sufficient.

The polarizing film and polarizer in which a hue angle and a chroma of a parallel hue are in a specified range of the present invention enables display excellent in the color reproductivity, in particular, when used in a transmission type TFT liquid-crystalline display. This polarizing film is, especially suitably used in automobile-mounting utilities such as car navigation system.

1. A polarizing film of a polyvinyl alcohol film in/on which dichroic dye is adsorbed and oriented, wherein a hue angle H is in a range of 105° to 150°, and a chroma C* is 7 or smaller, providing that a parallel hue is expressed on a chromaticity coordinate of (a*, b*).

2. The polarizing film according to claim 1, wherein a chroma C* is 3 or smaller, providing that an orthogonal hue is expressed on a chromaticity coordinate of (a*,b*).

3. A polarizer comprising a film having the optical compensating function and a polyvinyl alcohol film in/on which dichroic dye is absorbed and oriented, wherein a hue angle H is in a range of 105° to 150° , and a chroma C* is 9 or smaller providing that a parallel hue thereof is expressed on a chromaticity coordinate of (a*, b*).

4. The polarizer according to claim 3, wherein the film having the optical compensating function is laminated on at least one surface of the polyvinyl alcohol film.

5. The polarizer according to claim 3, wherein the hue angle H of the polyvinyl alcohol film is in a range of 105° to 150°, and the chroma C* of the polyvinyl alcohol film is 7 or smaller, providing that a parallel hue is expressed on a chromaticity coordinate of (a*, b*).

6. The polarizer according to claim 3, wherein a chroma C* is 3 or smaller providing that a crossed hue is expressed on a chromaticity coordinate of (a*,b*).

7. The polarizer according to claim 3 or 5, wherein the chroma C* of the polyvinyl alcohol film is 3 or smaller, providing that a crossed hue is expressed on a chromaticity coordinate of (a*,b*).

8. The polarizer according to claim 3, wherein the film having the optical compensation function comprises a liquid-crystalline compound and a substrate.

9. The polarizer according to claim 8, wherein the liquid-crystalline compound is a discotic liquid-crystal.

10. The polarizer according to claim 8, wherein the film having the optical compensation function is a film in which liquid-crystal compound is coated on the substrate.

11. The polarizer according to claim 8, wherein the film having the optical compensation function is obtained by coating liquid-crystal compound on the substrate.
